(19) United States
(12) Patent Application Publication
(10) Pub. No.: US 2008/0022810 A1
(43) Pub. Date: Jan. 31, 2008

(54) Wine bottle opener

(76) Inventor: David F. Panetti, Panama City Beach, FL (US)

Correspondence Address: J. WILEY HORTON, ESQUIRE;Pennington, Moore, Wilkinson, Bell & Dunbar, P.A., Post Office Box 10095, Tallahassee, FL, 32302-2095, US

(21) Appl. No.: 11/495,840

(22) Filed: Jul. 28, 2006

(51) Int. Cl. B67B 7/00

(52) U.S. Cl. 81/3.45; 30/1.5

(57) ABSTRACT

A bottle opener with combined foil cutting and cork extracting capabilities. The bottle opener includes a corkscrew and a handle. The handle has an integrated foil cutter which includes a bottle top receiver, a thumb slide, and a blade operatively connected to the thumb slide. The bottle top receiver is configured to receive the top of the bottle when the top of the bottle is inserted into the bottle top receiver. In the preferred embodiment, the bottle top receiver has a substantially cylindrical side wall along its internal perimeter. The thumb slide is provided on an exterior surface of the handle and is configured to slide back and forth along the exterior surface between a first position and a second position. The blade is operatively connected to the thumb slide so that it travels along with the thumb slide. When the thumb slide is moved from the first position to the second position, the blade projects into the interior of the bottle top receiver through a port in the side wall. In the preferred embodiment, the thumb slide and blade are spring biased to remain in the first position where the blade is hidden and does not project into the interior of the bottle top receiver.

### BACKGROUND OF THE INVENTION

1. Field of the Invention

This invention relates to the field of wine bottle opening devices. More specifically, this invention comprises a wine bottle opener with combination corkscrew and foil-cutting functionalities.

2. Description of the Related Art

Many bottled beverages are sealed with a plastic or metal foil cover which fits tightly over a cork. To open these bottled beverages, a two-step opening process is normally used. First, the foil or plastic cover covering the top of the bottle is cut and removed. Second, the cork is extracted from the mouth of the bottle. A foil cutter or knife is commonly used to remove the foil covering the top of the bottle to expose the cork. A separate cork screw is then used to extract the cork.

Many varieties of foil cutters and corkscrews exist for opening these types of bottled beverages. Although combination devices which employ the dual functionalities of a foil cutter and corkscrew exist, most people use two separate devices to open these bottles.

There are many reasons that prior art combination devices have been unsuccessful. First, many prior art combination devices are unnecessarily bulky or complex. Inventors have yet to propose a combination device that is ergonomic and comfortable to use. The bulkiness of existing devices also makes them difficult to store. In addition, because of their complexity, many of these combination devices are difficult to assemble and/or use.

Many prior art combination devices are also dangerous. Most combination devices employ a sharp blade to cut the plastic or foil cover. This sharp blade is often left exposed when the user employs the corkscrew. This can cause the user to accidentally cut himself or herself when opening the bottle.

It is therefore desirable to provide a wine bottle opener with combination foil-cutting and corkscrew functionalities that is also ergonomic and safe.

### BRIEF SUMMARY OF THE INVENTION

The present invention is a bottle opener with combined foil-cutting and cork-extracting capabilities. The bottle opener includes a corkscrew and a handle. The handle has an integrated foil cutter which includes a bottle top receiver, a thumb slide, and a blade operatively connected to the thumb slide. The bottle top receiver is configured to receive the top of the bottle when the top of the bottle is inserted into the bottle top receiver. In the preferred embodiment, the bottle top receiver has a substantially cylindrical side wall along its internal perimeter. The thumb slide is provided on an exterior surface of the handle and is configured to slide back and forth along the exterior surface between a first position and a second position. The blade is operatively connected to the thumb slide so that it travels along with the thumb slide. When the thumb slide is moved from the first position to the second position, the blade projects into the interior of the bottle top receiver through a port in the side wall. In the preferred embodiment, the thumb slide and blade are spring biased to remain in the first position where the blade is hidden and does not project into the interior of the bottle top receiver.

### BRIEF DESCRIPTION OF THE SEVERAL VIEWS OF THE DRAWINGS

FIG. 1 is a perspective view, showing the present invention.

FIG. 2 is a hidden line view, showing the present invention.

FIG. 3 is a hidden line view, showing the present invention.

FIG. 4 is a bottom view, showing the present invention.

REFERENCE NUMERALS IN THE DRAWINGS

| | | | |
|---|---|---|---|
| 10 | bottle opener | 12 | corkscrew |
| 14 | handle | 16 | thumb slide |
| 18 | connector passageway | 20 | connector |
| 22 | blade | 24 | spring |
| 26 | side wall | 28 | port |
| 30 | bottle top receiver | 32 | bottle |
| 34 | top | 36 | top mating surface |

### DETAILED DESCRIPTION OF THE INVENTION

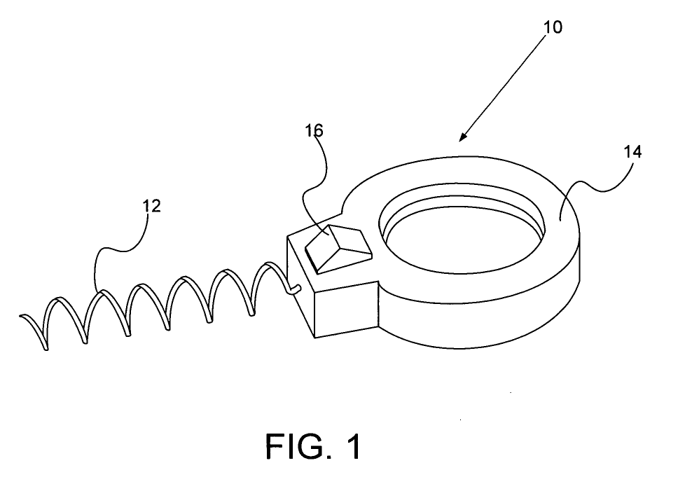

The present invention, bottle opener 10 with combined foil-cutting and cork-extracting capabilities, is illustrated in FIG. 1. Bottle opener 10 includes corkscrew 12 which is attached to handle 14. Handle 14 is generally shaped as a circular disk. Handle 14 has a flat top surface, a flat bottom surface, a substantially cylindrical external perimeter, and a hollow interior. Thumb slide 16 is slidably situated on the top surface of handle 14. The functionality of thumb slide 16 will be described in greater detail subsequently. The shape of handle 14 allows handle 14 to be comfortably gripped by the user both when bottle opener 10 is used as a foil cutter and when bottle opener 10 is used as a cork extractor. This shape also allows bottle opener 10 to be placed flat in a drawer or hung by a hook when stored.

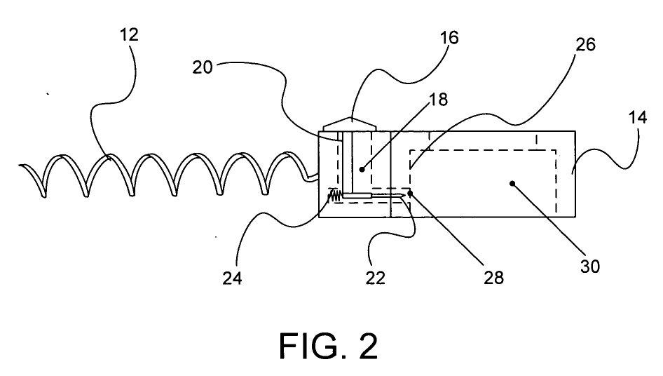

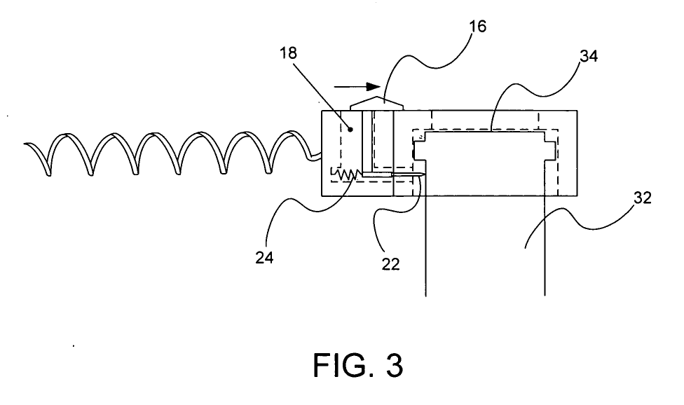

A hidden-line, side view of handle 14 is provided in FIG. 2. As mentioned previously, handle 14 has an integrated foil cutter. Blade 22 is operatively attached to the thumb slide 16 by connector 20. Thumb slide 16 is configured to slide back and forth along the top surface of handle 14 between a first position (shown in FIG. 2) and a second position (shown in FIG. 3). Connector 20 projects into handle 14 through the top exterior surface of handle 14 and into connector passageway 18 where it attaches to blade 22. Connector passageway 18 is provided in and perpendicular to the top exterior surface of handle 14. Connector passageway 18 is configured to allow connector 20 to move along with thumb slide 16 when said thumb slide 16 is moved between the first position and the second position. Accordingly, blade 22 travels along with and in the same direction as thumb slide 16 when thumb slide 16 is moved between the first position and second position.

Bottle top receiver 30 is provided in the bottom exterior surface of handle 14 and is configured to receive the top of the bottle when the top of the bottle is inserted into bottle top receiver 30 (as illustrated in FIG. 3). In the preferred embodiment, bottle top receiver 14 has a substantially cylindrical side wall 26 along its internal perimeter. When thumb slide 16 is moved from the first position to the second position, blade 22 projects into the interior of bottle top receiver 30 through port 28 in side wall 26. In the preferred embodiment, thumb slide 16 and blade 22 are spring biased by spring 24 to remain in the first position. The reader will note that when thumb slide 16 is in the first position, blade 22 is “hidden” and does not project into the interior of bottle top receiver 30. This feature reduces the risk of accidental injury since the user must apply force to thumb slide 16 to cause blade 22 to become “exposed.”

FIG. 3 illustrates the operation of the foil cutting mechanism of the present invention. Top 34 of bottle 32 is inserted into bottle top receiver 30 transversely with respect to the center axis of corkscrew 12. When top 34 of bottle 32 is inserted into bottle top receiver 30, thumb slide 16 is moved to the second position. While thumb slide 16 is held in the second position (such as with the user's thumb), handle 14 is rotated angularly around top 34 of bottle 32. Once handle 14 makes a complete revolution around top 34 of bottle 32, the foil cover wrapped over top 34 of bottle 32 will be cut into two pieces. The top piece of the foil cover may be then easily removed, thereby providing access to the cork.

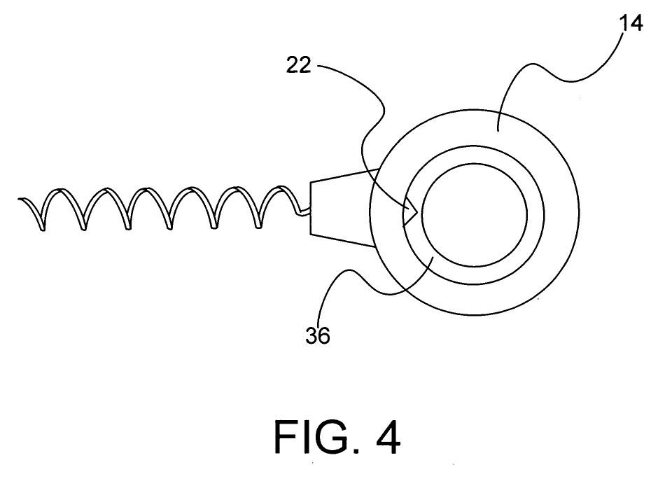

FIG. 4 is a bottom view of handle 14. Thumb slide 16 (not shown in the present illustration) is positioned in the second position so that blade 22 projects into the interior of the bottle top receiver. The bottle top receiver has top mating surface 36 which is configured to mate with the top 34 of bottle 32 when bottle 32 is inserted into the bottle top receiver. This feature maintains the alignment of blade 22 with the “cut” in the foil cover as handle 14 is rotated around the top of the bottle, allowing the foil to be cut into two pieces with only one revolution of handle 14.

The preceding description contains significant detail regarding the novel aspects of the present invention. It should not be construed, however, as limiting the scope of the invention but rather as providing illustrations of the preferred embodiments of the invention. As an example, corkscrew 12 may be any sort of device configured to extract a cork from the mouth of a bottle. Such a variation would not alter the function of the invention. Thus, the scope of the invention should be fixed by the following claims, rather than by the examples given.

Having described my invention, I claim:

1. A bottle opener for opening a bottle having a top, said top having a mouth and a cork situated within said mouth, said bottle having a cover fitted tightly over said top and said cork, said bottle opener comprising:
a. a corkscrew, having a first end and a second end, said first end configured to screw into said cork;
b. a handle, attached to said second end of said corkscrew, said handle including
i. a bottle top receiver, said bottle top receiver configured to receive said top of said bottle, said bottle top receiver having an internal perimeter large enough to receive said top of said bottle, a side wall along a portion of said internal perimeter, and a port in said side wall;
ii. a thumb slide on said handle, said thumb slide movable between a first position and a second position, and
iii. a blade operatively connected to said thumb slide so that said blade travels with said thumb slide when said thumb slide is moved between said first position, said blade configured to project through said port in said side wall when said thumb slide is moved from said first position to said second position.

2. The bottle opener of claim 1, said bottle top receiver further comprising a top mating surface configured to mate against said top of said bottle when said top of said bottle is inserted into said bottle top receiver.

3. The bottle opener of claim 1, wherein said blade is configured to be hidden when said thumb slide is positioned in said first position such that said blade does not project through said port in said side wall when said thumb slide is positioned in said first position.

4. The bottle opener of claim 1, wherein said thumb slide is biased to remain in said first position.

5. The bottle opener of claim 3, wherein said thumb slide is biased to remain in said first position.

6. The bottle opener of claim 1, wherein said corkscrew has a center axis extending between said first end and said second end, and wherein said bottle top receiver is configured to receive said bottle top when said bottle top is inserted into said bottle top receiver in a transverse direction with respect to said center axis of said corkscrew.

7. The bottle opener of claim 1, wherein said bottle opener is configured to cut said cover into two pieces when said top of said bottle is inserted into said bottle top receiver, said thumb slide is moved to said second position, and while said thumb slide is positioned in said second position, said handle is rotated angularly around said top of said bottle.

8. The bottle opener of claim 2, wherein said bottle opener is configured to cut said cover into two pieces when said top of said bottle is inserted into said bottle top receiver so that said top of said bottle mates with said top mating surface, said thumb slide is moved to said second position, and while said thumb slide is positioned in said second position, said handle is rotated angularly around said top of said bottle.

9. The bottle opener of claim 1, wherein said thumb slide and said blade are attached together by a connector such that said thumb slide is vertically offset from said blade and said thumb slide and said blade move together in said same direction when said thumb slide is moved from said first position to said second position.

10. The bottle opener of claim 1, wherein said thumb slide is positioned on an external surface of said handle and said thumb slide is configured to slide back and forth on top of said external surface.

11. The bottle opener of claim 9, wherein said thumb slide is positioned on an external surface of said handle and said thumb slide is configured to slide back and forth on top of said external surface.

12. The bottle opener of claim 11, wherein said connector projects into said handle through said external surface and into a connector passageway, said connector passageway provided in and perpendicular to said external surface, said connector passageway configured to allow said connector to move along with said thumb slide when said thumb slide is moved between said first position and said second position.

13. A bottle opener for opening a bottle having a top, said top having a mouth and a cork situated within said mouth, said bottle having a cover fitted tightly over said top and said cork, said bottle opener comprising:
a. a handle, having a top surface, a bottom surface, an interior, and an external perimeter gripping surface, said handle further including
i. a bottle top receiver extending through said bottom surface of said handle into said interior of said handle, said bottle top receiver configured to receive said top of said bottle when said top of said bottle is inserted therein, said bottle top receiver having a substantially cylindrical internal perimeter large enough to receive said top of said bottle, a side wall along a portion of said internal perimeter, and a port in said side wall;
ii. a thumb slide on said handle, said thumb slide movable between a first position and a second position, and
iii. a blade operatively connected to said thumb slide so that said blade travels with said thumb slide when said thumb slide is moved between said first position, said blade configured to project through said port in said side wall when said thumb slide is moved from said first position to said second position.

14. The bottle opener of claim 13, further comprising a corkscrew, said corkscrew having a first end and a second end, said second end of said corkscrew attached to said handle, and said first end of said corkscrew configured to screw into said cork.

15. The bottle opener of claim 13, wherein said thumb slide is positioned on said top surface of said handle and is configured to slide along said top surface of said handle when moved from said first position to said second position.

16. The bottle opener of claim 13, said bottle top receiver further comprising a top mating surface configured to mate against said top of said bottle when said top of said bottle is inserted into said bottle top receiver.

17. The bottle opener of claim 13, wherein said blade is configured to be hidden when said thumb slide is positioned in said first position such that said blade does not project through said port in said side wall when said thumb slide is positioned in said first position.

18. The bottle opener of claim 13, wherein said thumb slide is biased to remain in said first position.
